(19) United States
(12) Patent Application Publication
(10) Pub. No.: US 2018/0022054 A1
(43) Pub. Date: Jan. 25, 2018

(54) Apparatus and Method for the Making of a Pressure-Sensitive Construction from a Faceless Material

(71) Applicant: Frederic La Brie, Boucherville (CA)

(72) Inventor: Frederic LA BRIE, Boucherville (CA)

(21) Appl. No.: 15/554,033

(22) PCT Filed: Feb. 26, 2016
(86) PCT No.: PCT/CA2016/050201

§ 371 Date: Aug. 28, 2017

Related U.S. Application Data
(60) Provisional application No. 62/121,847, filed on Feb. 27, 2015.

(51) Int. Cl. B31D 1/02; C09J 7/02; B32B 7/12; B32B 37/02; B32B 7/06

(52) U.S. Cl. CPC B31D 1/02; B32B 37/02; B32B 7/06; B32B 7/12; C09J 7/0225; C09J 7/0296; B32B 37/26

(57) ABSTRACT

It is disclosed a pressure-sensitive faceless material adapted to be wound and form a convertible roll and methods for making the same. It is also disclosed an apparatus and method for the making of a pressure-sensitive material. The present disclosure is an improved, economical, and efficient method for label printer to make their own pressure-sensitive material. It uses a faceless material that is made from a standard release liner that has a low release layer on one side and a high release layer on the other. An adhesive is coated on either side and the product is rewound on itself. The production of the faceless material is manufactured in a centralized location with state of the art coating machines and expert personnel to ensure quality and stability of the product. The faceless material is then used by label printers to make different kind of pressure-sensitive constructions.

### CROSS-REFERENCE TO RELATED APPLICATIONS

The present patent application claims the benefits of priority of commonly assigned

U.S. provisional Patent Application No. 62/121,847, entitled “Pressure-sensitive construction from pressure-sensitive faceless material and method for making the same” and filed at the U.S.P.T.O. on Feb. 27, 2015, the content of which is incorporated herewith by reference.

### FIELD OF THE INVENTION

The present invention relates to a faceless material used to make a pressure-sensitive construction. The invention also relates to methods and apparatus involving the faceless material and how it is transformed into pressure sensitive material.

### BACKGROUND OF THE INVENTION

Typically, label printers use as their main raw material for their business, already made pressure-sensitive constructions. These constructions consist of a release liner, silicone applied on the release liner, an adhesive and a label face material. The manufactures of these constructions buy those 4 components and integrate them together to create constructions that label printers and end users need. Such pressure-sensitive liners or materials are described, for instance, in patents U.S. Pat. No. 5,084,317, U.S. Pat. No. 6,562,402, and U.S. Pat. No. 7,842,363 and in patent application US 2015/0007943.

Label printers have little or no to say on the type of pressure-sensitive constructions they can purchase, limiting them in the type of label they can offer to their customers, the end-users of the labels.

Label printers can only print on the face of the label face material. If they wish to protect the ink from mechanical, chemical of radiation deterioration, they need to protect the ink by adding a UV varnish or by laminating a clear film on top of the label. These two processes add a step in the manufacturing of the label and increase the cost. Label printer cannot print nice graphics on the back of the face material because it is already coated with an adhesive, since some labels need to have such a feature, label printer either print on the adhesive with bad printing results or need to use a 2-ply construction with a clear film and white paper or film, creating a thicker and more expensive label construction. A process that enables label printers to reverse print on clear film and double side print offer great advantages because they eliminate the UV varnish, lamination or special double ply construction. Such laminating machines are described in patents U.S. Pat. No. 4,393,117, U.S. Pat. No. 7,871,479, U.S. Pat. No. 7,905,981, and U.S. Pat. No. 8,371,354 and in patent application US 2012/0088051.

Some label printers have the capability to make their own label construction, giving them the flexibilities mentioned above. The disadvantage of this situation is that the machines used to make pressure-sensitive materials are very expensive and they need high skill operators, product development engineers and lab personnel to make sure they manufacture good product every day in an economical way compared to using material from companies that specialize in manufacturing pressure-sensitive materials and not labels.

Some label constructions with thick layer of adhesive or softer adhesives will create oozing of the adhesive around the contour of the label. When this happens, labels can stick to the back of the release liner when unwound in the labeling process, stopping the labeling process. A construction that has a silicone layer on the back of the release liner would eliminate this problem of labels sticking to the back of the liner during the labeling process.

Accordingly, another issue with prior art label printers is that a manufacturer needs to have on hand a roll of label for each type of label he wishes to offer his clients. This is space consuming and therefore limits the manufacturer in the quantity of type of label he is able to offer.

The present invention intends to solve this problem by providing an apparatus that allows a label manufacturer/printer to use any pressure-sensitive faceless material that he sees fit combined with a plurality of face material chosen by his clients. The present apparatus also allows printing on both face of the face material. Such a feature may be required regarding the field of utilization, such as health and beauty, beverage, groceries, retail stores and the likes.

### SUMMARY OF THE INVENTION

The invention is first directed to a method for the making of a pressure-sensitive material from a pressure-sensitive faceless material. The method comprises the steps of:
a) providing a pressure-sensitive faceless material comprising:
   a first layer made of a substrate and having a first side and a second side opposite to the first side,
   a second layer coated on the first side of the first layer and providing a first release value,
   a third layer coated on the second side of the first layer and providing a second release value superior to the first release value of the second layer, and
   a fourth layer coated on the second or third layer and comprising an adhesive material;
b) contacting the fourth layer of the pressure-sensitive faceless material with a face material having no release coating or a third release value superior to the second release value of the third layer;
c) separating the pressure-sensitive faceless material from the face material transferring as such the fourth layer to the face material;
d) flipping the pressure-sensitive faceless material in order to face the second layer with the adhesive layer transferred on the face material; and
e) contacting the second layer of the faceless material with the adhesive layer of the face material to form the pressure-sensitive material.

The invention is further directed to an apparatus for the making of a pressure-sensitive material from a pressure-sensitive faceless material, the pressure-sensitive faceless material comprising:
a first layer made of a substrate and having a first side and a second side opposite to the first side,
a second layer coated on the first side of the first layer and providing a first release value,
a third layer coated on the second side of the first layer and providing a second release value superior to the first release value of the second layer, and
a fourth layer coated on the second or third layer and comprising an adhesive material.

The apparatus comprises:
a frame;
a first contacting assembly mounted to the frame and adapted to receive the pressure-sensitive faceless material and to contact its fourth layer with a face material allowing to transfer the fourth layer from the pressure-sensitive faceless material to the face material when the pressure-sensitive faceless material and the face material separate when exiting the first contacting assembly;
a second contacting assembly mounted to the frame and adapted to receive the face material from the first contacting assembly and the pressure-sensitive faceless material from a flipping element mounted to the frame between the first and second contacting assemblies,
the flipping element allowing to flip the pressure-sensitive faceless material received from the first contacting assembly in order for its second layer to face the fourth layer transferred on the face material when they contact each other thanks to the second contacting assembly, forming as such the pressure-sensitive material.

The invention is yet further directed to a pressure-sensitive faceless material useful for the making of a pressure-sensitive material, the pressure-sensitive faceless material comprising:
a first layer made of a substrate and having a first side and a second side opposite to the first side,
a second layer coated on the first side of the first layer and providing a first release value,
a third layer coated on the second side of the first layer and providing a second release value superior to the first release value of the second layer, and
a fourth layer coated on the second or third layer and comprising an adhesive material.

The present disclosure is an improved, economical, and efficient method for label printer to make their own pressure-sensitive material.

The present invention allows using a faceless material that is made from a standard release liner with a low release layer on one side and a high release layer on the other side. An adhesive is coated on either side and the product is rewound on itself. The production of the faceless material is manufactured in a centralized location with state of the art coating machines and expert personnel to ensure quality and stability of the product. The faceless material is then used by label printers to make different kind of pressure-sensitive constructions.

The rolls of pressure-sensitive faceless are shipped to many different label printers for them to use in one embodiment of the present invention. A simple delamination-turnbar-relamination machine enables label manufacturers to use any label face material that they wish and reverse print or double-side print, which is not possible with prior art apparatus since the face material is already laminated with the pressure-sensitive material.

Because of the centralization of the coating process and decentralization of the lamination process and choice of face material, the total construction is more economical than standard pressure-sensitive construction and opens the possibility to different types of construction not available today to label printers and end users.

Other advantages of the method concern the possibility to coat special coatings on the face material before or after the delamination-turnbar-relamination process. Example: coatings for digital printing or for ink adhesion. Labels could also be printed by a digital print engine before or after the delamination-turnbar-relamination process. Labels could also be die-cut and rewound into small rolls in-line completing the final step of label manufacturing.

Another advantage is that the finish label construction has silicone on the back of the release liner, eliminating the risk of having die-cut labels delaminating during labelling because of adhesive oozing. This also permits higher tension on the finished label roll, thus easier to handle rolls.

Another advantage would be the possibility to produce a great variety of labels without having to keep in stock large quantities of different type of label as it is currently the case. Up to now, if printers want to offer 60 different types of labels, they must keep in stock one roll of each type. In the present invention, the printer could keep in stock only 10 rolls of different type of labels and 6 rolls of different faceless material to produce up to 60 different types of labels. There is thus an economy in storage space and cost.

The faceless material and delamination-turnbar-relamination method permits label construction on a low release layer for high speed automatic labelling.

Other and further objects and advantages of the present invention will be apparent upon an understanding of the illustrative embodiments about to be described or will be indicated in the appended claims, and various advantages not referred to herein will occur to one skilled in the art upon employment of the invention in practice.

### BRIEF DESCRIPTION OF THE FIGURES

The above and other objects, features and advantages of the invention will become more readily apparent from the following description, reference being made to the accompanying drawings in which:

FIG. 1 is a side view of the faceless material construction according to a preferred embodiment of the invention;

FIG. 2a is a side view of the faceless construction unwound for its roll format according to a preferred embodiment of the invention;

FIG. 2b is a perspective view of the faceless construction unwound for its roll format according to a preferred embodiment of the invention;

FIG. 3 is a schematic illustration of an apparatus that transform the faceless material into pressure-sensitive material according to a first preferred embodiment of the invention;

FIG. 4 is a schematic illustration of an apparatus that transform the faceless material into pressure-sensitive material according to a second preferred embodiment of the invention.

FIG. 5 is a front view of an apparatus that transforms the faceless material into pressure-sensitive material according to another preferred embodiment of the invention.

FIG. 6 is a perspective view of the apparatus illustrated on FIG. 5.

### DETAILED DESCRIPTION OF PREFERRED EMBODIMENTS

A novel method and apparatus for the making of a pressure-sensitive construction from a faceless material will be described hereinafter. Although the invention is described in terms of specific illustrative embodiments, it is to be understood that the embodiments described herein are by way of example only and that the scope of the invention is not intended to be limited thereby.

The Pressure-Sensitive Faceless Material:

As aforesaid, the invention is directed to a pressure-sensitive faceless material useful for the making of a pressure-sensitive material. The pressure-sensitive faceless material comprises:
a first layer made of a substrate, preferably a liner made of paper or polyester, and having a first side and a second side opposite to the first side,
a second layer, preferably comprising silicone, coated on the first side of the first layer and providing a first release value preferably from 3 to 30 grams per inch, more preferably 5 to 10 grams per inch,
a third layer, preferably comprising silicone, coated on the second side of the first layer and providing a second release value superior to the first release value of the second layer, preferably from 20 to 200 grams per inch, more preferably from 30 to 50 grams per inch, and
a fourth layer, preferably an acrylic or hotmelt, coated on the second or third layer and comprising an adhesive material.

The pressure-sensitive faceless material by its specific characteristics is particularly adapted to be used in the methods and apparatus described herein. The difference of release values allows the fourth layer to remain adjacent to the third layer when the roll of pressure-sensitive material is unwound.

The Method:

As aforesaid, the invention is also directed to a method for the making of a pressure-sensitive material from a pressure-sensitive faceless material. The method comprises at least the following steps.

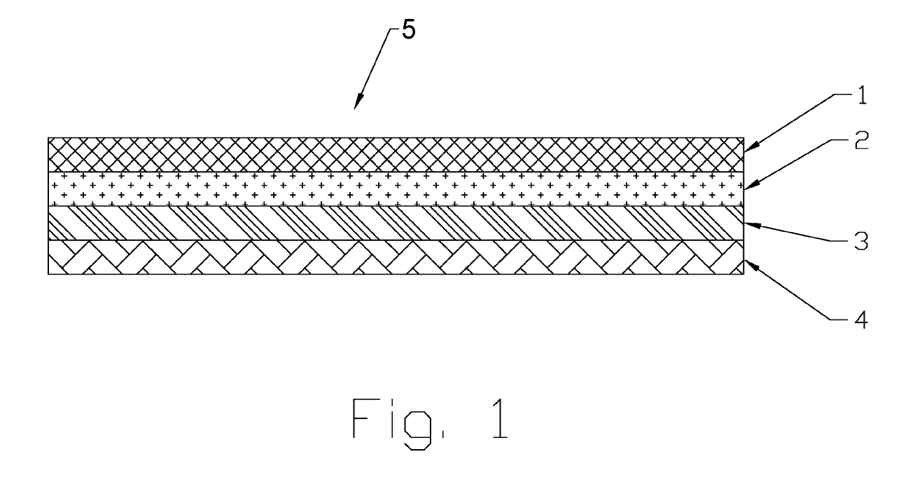

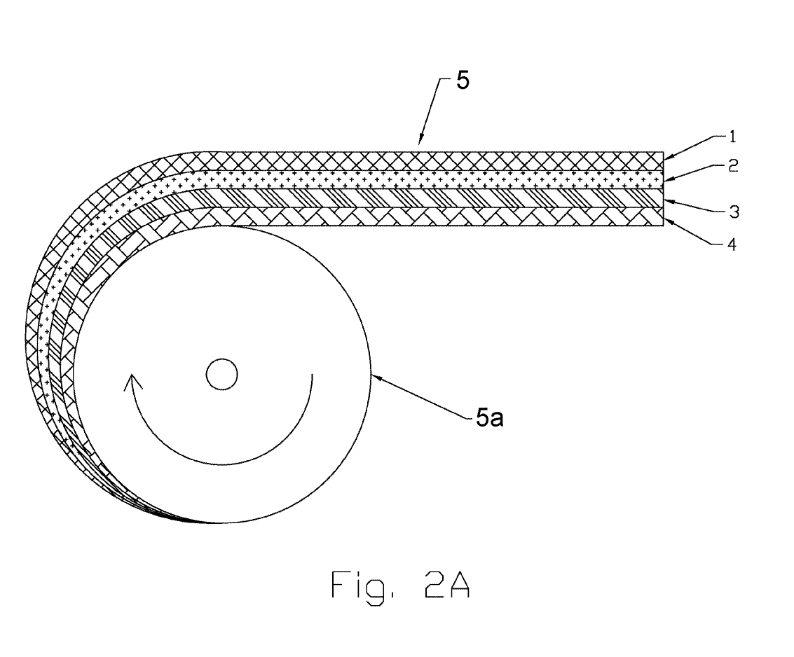

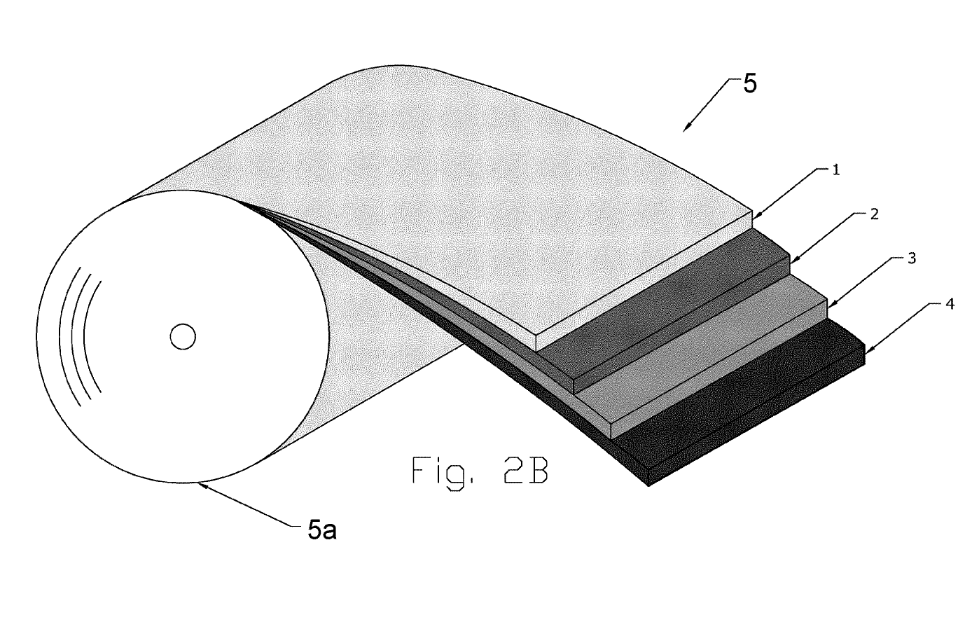

The first step a) of the method consists in providing a pressure-sensitive faceless material. The pressure-sensitive faceless material is as described herein above. An example of pressure-sensitive faceless material is also illustrated on FIGS. 1, 2A and 2B.

The method also comprises the second step b) of contacting the fourth adhesive layer of the pressure-sensitive faceless material with a face material. A face material may have no release coating (i.e. for instance a plain paper or filmic material). The face material may also have a third release value. In that case, the third release value is at least superior to the second release value of the third layer to allow the fourth layer to be transferred from the pressure-sensitive material to the face material.

By “contacting”, it is meant that the two “webs” are put in contact with a sufficient pressure for allowing the fourth adhesive layer to adhere to the face material. As detailed herein after, such step can be typically achieved by the use of a nip station or others means known in the art for contacting pressure-sensitive material.

The method also comprises a third step c) where the pressure-sensitive faceless material is separated from the face material after the previous contact. The subsequent steps of contacting and separating allows the fourth adhesive layer to transfer to the face material. The pressure-sensitive faceless material and the face material are both separated when exiting the first contacting station, or nip station. This is achieved by routing both materials through different paths after exiting the nip station.

The method also comprises a fourth step d) consisting in flipping the pressure-sensitive faceless material. This step allows the second layer to face with the adhesive layer transferred on the face material when contacting a second time the face material in the subsequent step. The flipping step may be achieved for instance by the use of a turn bar system or other means well known in the art.

The method also comprises a fifth step e) of contacting the second layer of the pressure-sensitive faceless material once flipped with the adhesive layer transferred on the face material. After being flipped, both materials are routed to a second contacting assembly, such as a nip station or similar to the first contacting assembly or station. By “contacting” it is meant that sufficient pressure is applied as to allow both materials to bond as to form a sole web of pressure-sensitive material. Both pressure-sensitive faceless material and face material remain stick together thanks to the adhesive of the fourth layer and the pressure-sensitive material is formed.

According to a preferred embodiment, the method may further comprise the steps of unwinding a first roll of the pressure sensitive faceless material and unwinding a second roll of the face material before the step b). This step is often required as such materials are typically shipped in rolls. Apparatus known in the art, such as air mandrels, may be used to carry that step. It may also be required to motorize the unwinding device because of the weight of the rolls.

According to a preferred embodiment, the method may further comprise the step of aligning the pressure-sensitive faceless material with the face material before step b) of contacting the fourth layer of the pressure-sensitive faceless material with the face material. According to a preferred embodiment, the method may further comprise the step of aligning the pressure-sensitive faceless material flipped in step c) with the face material before step d) of contacting the second layer of the faceless material with the adhesive layer of the face material. By “aligning” it is meant that the roll of pressure sensitive material may be moved as to ensure that the edges of both the pressure-sensitive faceless material and the face material are superposed. For instance, a sensor, or camera, can be used to detect any deviation and control an actuator that moves the roll. These steps can be achieved by using a web alignment system or other means known in the art such as a web guide. These steps ensure that there is no deviation in the materials that will end up in material losses, thus profit losses. The web alignment system ensures that the edges of both webs are superposed.

According to a preferred embodiment, the method may further comprise the step of winding the pressure-sensitive material after step e), to form a roll of the pressure-sensitive material to facilitate shipping. Understandably, a motorized apparatus, such as an air mandrel, may be required to wrap the pressure-sensitive web around the roll.

According to a preferred embodiment, the method may further comprise the step of cutting shapes in the pressure-sensitive material after step e) of contacting the second layer of the faceless material with the adhesive layer of the face material. It is understood that the shapes may vary according to the clients needs.

According to a preferred embodiment, the method may further comprise the step of printing a print on the face material before step b) of contacting the fourth layer of the pressure-sensitive faceless material with the face material. The method may use a pre-printed face material or, in other embodiment, may also offer clients the possibility to print custom logos, shapes, or the likes.

According to a preferred embodiment, the method may further comprise the step of coating the face material with a top coat of material before the step of printing, the coat being adapted to allow the print to remain on the face material. This step is required if the face material is not suited to allow the print to remain or to adhere to the face material. If a top coat is applied, the face material should be preferably dried before the step of printing to avoid ink smudging or other undesired phenomena.

The compositions of the pressure-sensitive faceless material and the face material used in the present method are described herein above.

The Apparatus:

As aforesaid, the invention is also directed to an apparatus for the making of a pressure-sensitive material from a pressure-sensitive faceless material. The pressure-sensitive faceless material is described in detail herein above.

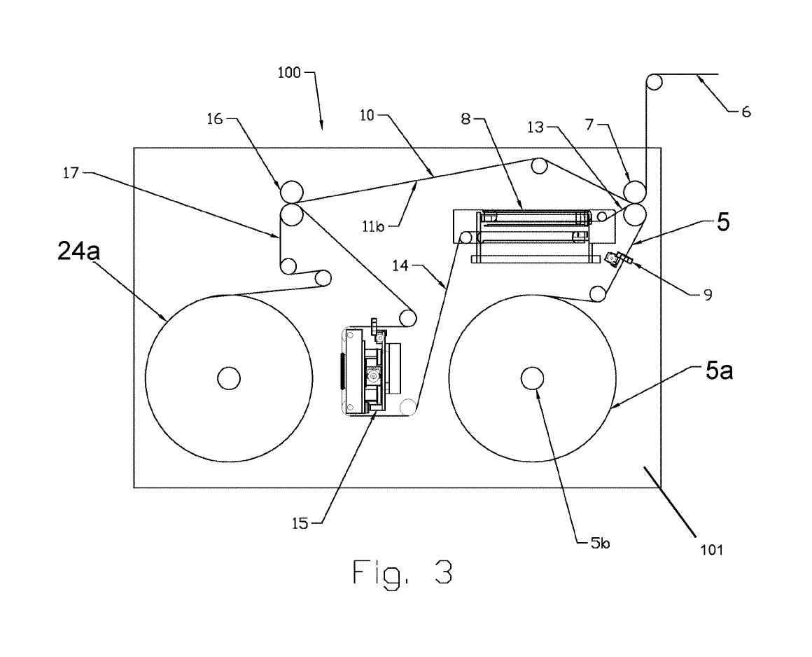

Preferred embodiments of the apparatus are illustrated in FIGS. 3, 5 and 6 and typically comprises a frame, a first contacting assembly mounted to the frame and adapted to receive the pressure-sensitive faceless material and to contact its fourth layer with a face material allowing to transfer the fourth layer from the pressure-sensitive faceless material to the face material when the pressure-sensitive faceless material and the face material separate when exiting the first contacting assembly. To allow separation, both webs are each routed to a different path.

The apparatus also comprises a second contacting assembly mounted to the frame and adapted to receive the face material from the first contacting assembly and the pressure-sensitive faceless material from a flipping element mounted to the frame between the first and second contacting assemblies. The first and second contacting assemblies can be nip stations comprising two rolls in contact and adapted to apply sufficient pressure on the materials to allow the two webs to bond together. Understandably, it may be required to motorize the nip stations to ensure a continuous and smooth flow of webs in the apparatus.

As aforesaid, the flipping element allows flipping the pressure-sensitive faceless material received from the first contacting assembly in order for its second layer to face the fourth layer transferred on the face material when they contact each other thanks to the second contacting assembly, forming as such the pressure-sensitive material. The flipping element may be for instance a turn bar system or other means known in the art.

According to a preferred embodiment, the apparatus may further comprise an alignment system mounted on the frame between the flipping element and the second contacting assembly to align the pressure-sensitive faceless material flipped by the flipping element, or turn bar system, with the face material before being received by the second contacting assembly or nip station. This alignment system ensures that there is no deviation in the materials that will end up in material losses, thus profit losses. The web alignment system ensures that the edges of both webs are superposed.

According to a preferred embodiment, a first and second unwinding elements may be mounted on the frame of the apparatus for supporting a first roll of the pressure sensitive faceless material and a second roll of the face material. The unwinding elements may be for instance air mandrels and may be motorized to ensure a smooth flow of materials. The unwinding elements may also allow axial movement of the first and second rolls.

Accordingly, the first and second unwinding elements, or air mandrels, may each further comprise an actuator adapted to axially move each roll in order to align the pressure-sensitive faceless material and the face material before being received by the first contacting assembly. An actuator, controlled by a sensor, such as a camera, is mounted between the frame and the unwinding element to axially move the roll to achieve proper alignment of the webs.

A winding element, such as an air mandrel, may be mounted on the frame and adapted to wind the pressure-sensitive material to form a roll of the pressure-sensitive material. The winding element is preferably motorized to pull the pressure-sensitive material from the second contacting assembly, or nip station.

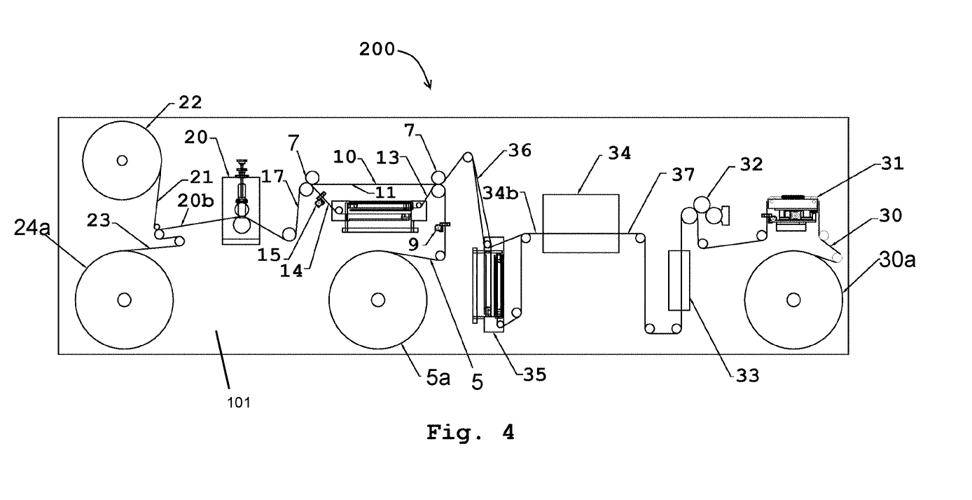

In another embodiment depicted in FIG. 4, the apparatus may further comprise a cutting station located after the second contacting assembly on the frame for cutting shapes in the pressure-sensitive material. The shapes are determined by the client.

Still according to the embodiment of FIG. 4, the apparatus may further comprise a printing device located before the first contacting assembly for printing a print on the face material. Accordingly, the apparatus may be fed blank face material. Such embodiment proposes more customisation options to the client. Regarding the material used for the face material, it may be required to apply a top coat to allow proper adhesion of the print to the material. In such a case, a drying station may be required to dry the top coat before receiving the print. This step may be required to avoid, or limit, ink smudging.

### EXAMPLES

FIG. 1 shows a front plan view of the pressure-sensitive faceless material construction 5 (hereafter named “faceless material”) consisting of four layers. Layer 1 is a material having a low release value, such as a silicone layer with low release values of 3 to 30 Win, preferably of 5-10 Win. Silicone technology could be radiation cured, solventless, water-based or solvent-based. Silicone could be from Bluestar Silicones, Dow Corning, Evonik or Momentive.

The pressure-sensitive faceless material is coated on the front/smooth side of a release liner material 2 that can be made of a material with typical physical properties of materials used as release liners in the manufacturing of labels. For instance, paper, polyester, BOPP, Poly coated liner of any type of material that can be used as a release liner for labels. Paper release liner could be Boise, Verso, Twin Rivers. Film release liner could be from SKC, Multi-Plastics, Dupont, and Mitsubishi Polyester.

Another release layer 3 of a material having a high release value, for instance values of 20 to 200 Win, preferably 30-50 g/in is applied on the back/front side of the release liner 2. Silicone technology could be radiation cured, solventless, water-based or solvent-based. Silicone could be from Bluestar Silicones, Dow Corning, Evonik or Momentive.

In the example illustrated on FIG. 1, an adhesive 4 is applied on the high release layer 3 of the release liner 2. It is to be understood that the adhesive can be also applied on the low release layer 1. Adhesive type can be water based acrylics, solvent based acrylics or rubber, hotmelt or UV Acrylic hotmelts. Adhesive could be from Henkel, Bostik, Dow, Franklin or Novamelt.

FIGS. 2a and 2b show the faceless material 5 of FIG. 1 in a roll format 5a. It explains how faceless material 5 can be unwound from a roll 5a. In roll format, adhesive 4 is laminated between layer 3 and layer 1, two release layers. While unwinding the roll 5a, the adhesive always stays on release layer 3. This is achieved by having different release values on each side of the adhesive 4. Since release values of release layer 3 is higher that release layer 1, the adhesive 4 stays on release layer 3.

FIG. 3 shows an example embodiment of an apparatus 100 that will use a convertible roll 5a, mounted on a frame 101, and convert it into pressure sensitive material 24. The roll 5a is placed on an unwinding element 5b, such as an air shaft mandrel or the like, and is pulled by a nip station 7. Before entering the nip station 7, the roll 5a is aligned using for instance a sensor 9 that controls an actuator that moves the air mandrel 5b in cross web direction to adjust the faceless material 5 laterally to a faceless web 6 coming from another process like for instance a digital press, a standard analog press (flexographic, offset, letterpress, . . . ) or a standard unwind stand.

Since the adhesive 4 of the faceless material 5 is on the release layer 3, when it is laminated to web 6, the adhesive is transferred to the bottom surface 11b of web 6, forming a new web 10. Just after the lamination in the nip station 7, the faceless material 5 becomes a second web 13 that comprises only of the layers 1, 2, 3 of the web illustrated on FIG. 1. The second web 13 then goes through a turn bar system 8 that flips the second web 13 upside down, i.e. the side that has the low release silicone material 1 is now facing up giving the web 14. The web 14 then goes through another web alignment system 15 to realign it with the web 10. As aforesaid, the web 10 is coming from the lamination nip station 7 and has adhesive 4 on its bottom layer 11b. Bottom layer 11b and adhesive 4 is laminated with the low release layer 1 of the release material 2 of the web 14 in the nip station 16. A final laminated web 24 is then produced and can get rewound in a roll format 24a supported by a winding element 24b.

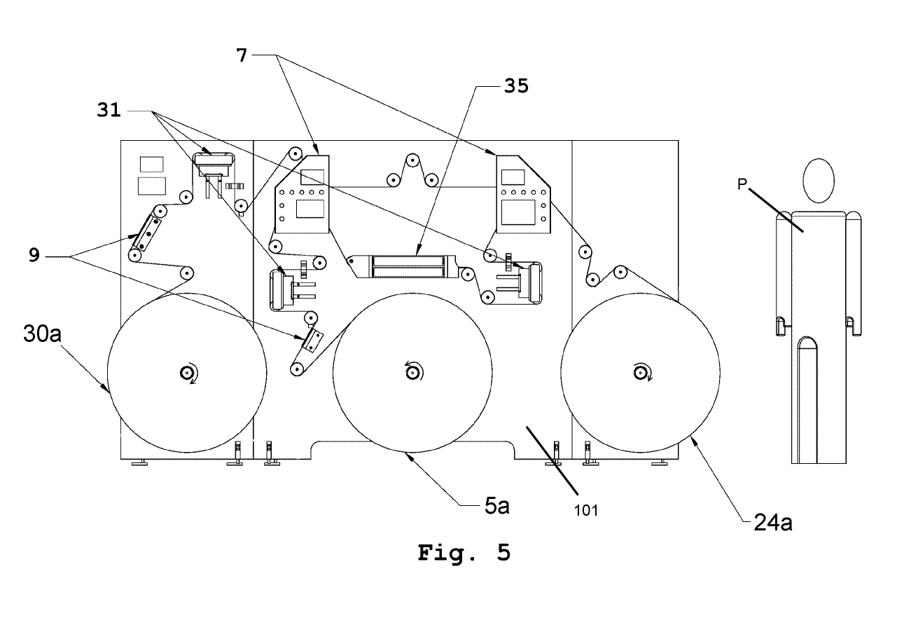

FIGS. 4 and 5 show another example of an apparatus 200 according to another embodiment of the invention. Roll 5a is still placed on an air shaft mandrel 5b and is pulled by a nip station 7, while being pressed between the rolls of the nip station 7. The unwounded faceless material 5 is aligned using a sensor 9 that controls an actuator that move the air mandrel 5b in cross web direction to adjust the faceless material 5 laterally to a web 36. The sensor 9 can be replaced by a simpler web guide.

In FIGS. 4 and 5, web 36 comes from unprinted or pre-printed web 30b. Web 30b is unwound from roll 30a and aligned by web guide 31, it goes through a printing/coating station 32 that can either apply a top coat to improve downstream printability or it can print normal printing. The webs can be dried in a dryer 33 by using either UV, hot air or IR depending on the chemistry of the webs. Ready to print, web 37 then goes to a monochrome or color digital print device 34. This device 34 can utilize UV inkjet, WB inkjet, Electrophotography or any types of digital technology. Printed web 34b can be flipped upside-down by turn bar 35 or not and go directly into the nip station 7.

Web 36 is then converted into a pressure sensitive material as described in FIG. 3 but before getting rewound in roll format 24a it goes through a die-cutting station 20 to cut the shape of the label. Waste matrix 21 is removed from die-cut web 20b and rewound in a roll 22, vacuumed directly in a waste container or disposed in any known method. Printed and die-cut web 23 is rewound in a roll 24a.

Now referring to FIGS. 2B, 5, and 6, the roll 30a of pre-printed web and the roll 5a of faceless material 5 are unrolled and each pass through a splicing table 9 for before being aligned by the web guide 31. The pre-printed web 30 then meets the faceless material 5 in the nip station 7 for transferring the adhesive 4 from the faceless material 5 to the web 30. The faceless material is then flipped by the turn bar 35 before meeting the web 30 in a second nip station 7. The material that leaves the nip station now has five layers, the web being adjacent to the layer 3 having a high release value of 20 to 200 g/in, preferably 30-50 g/in. The adhesive layer 4 is then adjacent to the layer 1 having a low release value of 3 to 30 g/in, preferably 5-10 g/in.

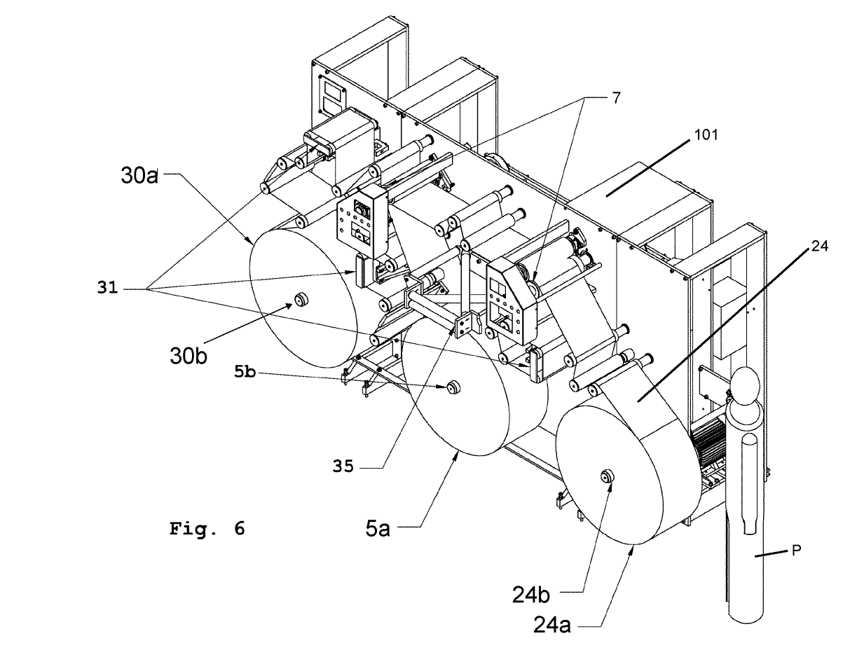

Referring to FIGS. 5 and 6, the size of the apparatus may be appreciated when compared to the size of a person identified on the Figures with the letter P.

The splicing tables 9 are used to connect the end of a roll 30a or 5a with the beginning of a new roll 30a or 5a.

While illustrative and presently preferred embodiment(s) of the invention have been described in detail hereinabove, it is to be understood that the inventive concepts may be otherwise variously embodied and employed and that the appended claims are intended to be construed to include such variations except insofar as limited by the prior art.

What is claimed is:

1. A method for the making of a pressure-sensitive material from a pressure-sensitive faceless material, the method comprising the steps of:
a) providing a pressure-sensitive faceless material comprising:
a first layer made of a substrate and having a first side and a second side opposite to the first side,
a second layer coated on the first side of the first layer and providing a first release value,
a third layer coated on the second side of the first layer and providing a second release value superior to the first release value of the second layer, and
a fourth layer coated on the second or third layer and comprising an adhesive material;
b) contacting the fourth layer of the pressure-sensitive faceless material with a face material having no release coating or a third release value superior to the second release value of the third layer;
c) separating the pressure-sensitive faceless material from the face material transferring as such the fourth layer to the face material;
d) flipping the pressure-sensitive faceless material in order to face the second layer with the adhesive layer transferred on the face material; and
e) contacting the second layer of the faceless material with the adhesive layer of the face material to form the pressure-sensitive material.

2. The method as claimed in claim 1, further comprising the step of aligning the pressure-sensitive faceless material flipped in step c) with the face material before step d) of contacting the second layer of the faceless material with the adhesive layer of the face material.

3. The method as claimed in claim 1 or 2, wherein step a) comprises the step of unwinding a first roll of the pressure sensitive faceless material and wherein the method further comprises before step b) a step of unwinding a second roll of the face material.

4. The method as claimed in any one of claims 1 to 3, further comprising the step of aligning the pressure-sensitive faceless material with the face material before step b) of contacting the fourth layer of the pressure-sensitive faceless material with the face material.

5. The method as claimed in any one of claims 1 to 4, further comprising the step of winding the pressure-sensitive material to form a roll of the pressure-sensitive material.

6. The method as claimed in any one of claims 1 to 5, further comprising the step of cutting shapes in the pressure-sensitive material after step of contacting the second layer of the faceless material with the adhesive layer of the face material.

7. The method as claimed in any one of claims 1 to 6, further comprising a step of printing a print on the face material before step b) of contacting the fourth layer of the pressure-sensitive faceless material with the face material.

8. The method as claimed in claim 7, further comprising a step of coating the face material with a top coat of material before the step of printing, the coat being adapted to allow the print to remain on the face material or to improve a quality of the print.

9. The method as claimed in claim 8, further comprising a step of drying the face material after the step of coating and before the step of printing.

10. The method as claimed in any one of claims 1 to 9, wherein the first release value of the second layer is from 3 to 30 grams per inch.

11. The method as claimed in any one of claims 1 to 10, wherein the first release value of the second layer is from 5 to 10 grams per inch.

12. The method as claimed in any one of claims 1 to 11, wherein the second release value of the third layer is from 20 to 200 grams per inch.

13. The method as claimed in any one of claims 1 to 12, wherein the second release value of the third layer is from 30 to 50 grams per inch.

14. The method as claimed in any one of claims 1 to 13, wherein the second and third layers comprise silicone.

15. The method as claimed in any one of claims 1 to 14, wherein the fourth layer is an acrylic or a hotmelt adhesive.

16. The method as claimed in any one of claims 1 to 15, wherein the first layer is a liner made of paper, polyester or polypropylene.

17. An apparatus for the making of a pressure-sensitive material from a pressure-sensitive faceless material, the pressure-sensitive faceless material comprising:
a first layer made of a substrate and having a first side and a second side opposite to the first side,
a second layer coated on the first side of the first layer and providing a first release value,
a third layer coated on the second side of the first layer and providing a second release value superior to the first release value of the second layer, and
a fourth layer coated on the second or third layer and comprising an adhesive material;
the apparatus comprising:
a frame;
a first contacting assembly mounted to the frame and adapted to receive the pressure-sensitive faceless material and to contact its fourth layer with a face material allowing to transfer the fourth layer from the pressure-sensitive faceless material to the face material when the pressure-sensitive faceless material and the face material separate when exiting the first contacting assembly;
a second contacting assembly mounted to the frame and adapted to receive the face material from the first contacting assembly and the pressure-sensitive faceless material from a flipping element mounted to the frame between the first and second contacting assemblies,
the flipping element allowing to flip the pressure-sensitive faceless material received from the first contacting assembly in order for its second layer to face the fourth layer transferred on the face material when they contact each other thanks to the second contacting assembly, forming as such the pressure-sensitive material.

18. The apparatus as claimed in claim 17, wherein the flipping element comprises a turn bar system.

19. The apparatus as claimed in claim 17 or 18, wherein the first and second contacting assemblies each comprises a nip station having two parallel rolls adapted to receive and press together the pressure-sensitive faceless material and the face material.

20. The apparatus as claimed in claim 19, wherein the first and/or second contacting assemblies are motorized for pulling on the pressure-sensitive faceless material and the face material.

21. The apparatus as claimed in any one of claims 17 to 20, wherein the apparatus further comprises an alignment system mounted on the frame between the flipping element and the second contacting assembly to align the pressure-sensitive faceless material flipped by the flipping element with the face material before being received by the second contacting assembly.

22. The apparatus as claimed in any one of claims 17 to 21, wherein the frame supports a first unwinding element for supporting a first roll of the pressure sensitive faceless material and a second unwinding element for supporting a second roll of the face material.

23. The apparatus as claimed in claim 22, wherein the first and second unwinding elements each comprises a shaft supported by the frame and adapted for receiving the rolls and unwinding the rolls.

24. The apparatus as claimed in claim 23, wherein the first and second unwinding elements each further comprise an air mandrel adapted to allow the first and second rolls to rotate.

25. The apparatus as claimed in claim 24, wherein the first and second unwinding elements each further comprises an actuator adapted to axially move each roll in order to align the pressure-sensitive faceless material and the face material before being received by the first contacting assembly.

26. The apparatus as claimed in claim 25, wherein the actuator is controlled by a sensor mounted on the frame between the first roll and the first contacting assembly.

27. The apparatus as claimed in any one of claims 17 to 24, further comprising at least one web guide mounted on the frame before the first and/or second contacting element to axially align the pressure-sensitive faceless material before contacting the face material.

28. The apparatus as claimed in any one of claims 17 to 27, wherein the apparatus further comprises a winding element mounted on the frame and adapted to wind the pressure-sensitive material and form a form a roll of the pressure-sensitive material.

29. The apparatus as claimed in claim 28, wherein the winding element is motorized.

30. The apparatus as claimed in any one of claims 17 to 29, wherein the apparatus further comprises a cutting station located after the second contacting assembly on the frame for cutting shapes in the pressure-sensitive material.

31. The apparatus as claimed in any one of claims 17 to 30, wherein the apparatus further comprises a printing device located before the first contacting assembly for printing a print on the face material.

32. The apparatus as claimed claim 31, wherein the apparatus further comprises a coating station located before the printing device and adapted to apply a top coat to the face material before printing on the face material.

33. The apparatus as claimed in claim 32, wherein the apparatus further comprises a drying station located after the coating station and before the printing station and adapted for drying the face material exiting the printing station.

34. A pressure-sensitive faceless material useful for the making of a pressure-sensitive material, the pressure-sensitive faceless material comprising:
a first layer made of a substrate and having a first side and a second side opposite to the first side,
a second layer coated on the first side of the first layer and providing a first release value,
a third layer coated on the second side of the first layer and providing a second release value superior to the first release value of the second layer, and
a fourth layer coated on the second or third layer and comprising an adhesive material.

35. The pressure-sensitive faceless material as claimed in claim 34, wherein the first release value of the second layer is from 3 to 30 grams per inch.

36. The pressure-sensitive faceless material as claimed in claim 34 or 35, wherein the first release value of the second layer is from 5 to 10 grams per inch.

37. The pressure-sensitive faceless material as claimed in any one of claims 34 to 36, wherein the second release value of the third layer is from 20 to 200 grams per inch.

38. The pressure-sensitive faceless material as claimed in any one of claims 34 to 37, wherein the second release value of the third layer is from 30 to 50 grams per inch.

39. The pressure-sensitive faceless material as claimed in any one of claims 34 to 38, wherein the second and third layers comprise silicone.

40. The pressure-sensitive faceless material as claimed any one of claims 34 to 39, wherein the fourth layer is an acrylic or holtmelt adhesive.

41. The pressure-sensitive faceless material as claimed in any one of claims 34 to 40, wherein the first layer is a liner made of paper, polyester or polypropylene.
